(19) United States
(12) Patent Application Publication
(10) Pub. No.: US 2012/0079121 A1
(43) Pub. Date: Mar. 29, 2012

(54) System and method for dynamic adaptive player cells for multi-player environments

(75) Inventors: Andrew Rapo, Studio City, CA (US); Lancelot Priebe, Kelowna (CA)

(73) Assignee: DISNEY ENTERPRISES, INC, BURBANK, CA (US)

(21) Appl. No.: 12/924,523

(22) Filed: Sep. 28, 2010

(51) Int. Cl. G06F 15/16

(52) U.S. Cl. 709/227

(57) ABSTRACT

There is provided a system and method for dynamic adaptive player cells for multi-player environments. There is provided a method comprising establishing connections to host clients over a network, evaluating matching criteria to assign the clients to player cells, reevaluating the matching criteria to determine client transitions of the clients within the player cells, and sending, using the connections, data of the client transitions to output a visual translation of the client transitions to displays connected to the clients. By continually reevaluating the matching criteria and reconfiguring the composition of the player cells using low cost distributed server infrastructure, users may be optimally matched to the most relevant and interesting users. Additionally, by using the visual translation to depict the client transitions in a natural looking manner, the operation of the player cells can be made transparent to users, thereby removing interface complexity and attracting novice users.

### BACKGROUND OF THE INVENTION

1. Field of the Invention

The present invention relates generally to interactive online gaming. More particularly, the present invention relates to load balancing for interactive online gaming.

2. Background Art

Multi-player online games or virtual worlds with many concurrent clients require significant amounts of computational resources and are often serviced with a distributed network of servers. The distribution of clients to servers may be approached conventionally as a straightforward load-balancing problem. By focusing on performance parameters such as server user load, geographic proximity, and network latency, users can be optimally grouped to specific servers or groups of servers.

However, such performance oriented load-balancing approaches tend to ignore other important metrics, such as the social aspects of online communities. For example, certain groups of users, such as friends or guild clans, may generally desire to see and communicate with each other. Using a solely performance based metric, these groups of users may end up separated and isolated on different servers.

One conventional method of addressing this separation problem is to provide users with ways to negotiate and manually specify a specific game instance or server to join. Unfortunately, this inelegant workaround places extra burdens on users, breaks environmental immersion or “the fourth wall”, and may not be well understood by all users, particularly newer and younger users unfamiliar with the technical issues concerning multi-player online environments.

Another method is simply to consolidate the distributed network of servers into a single monolithic server. However, this method requires costly high performance server hardware to adequately service a client population size typically associated with a multi-player online application. Moreover, a single monolithic server attempting to concurrently service several networked clients will inevitably run into network related quality of service issues such as network lag and timeouts, reducing the quality of the user experience. Thus, until significant improvements occur in network infrastructure, the monolithic server remains practical for only a limited subset of multi-player online applications.

Accordingly, there is a need to overcome the drawbacks and deficiencies in the art by providing a transparent and cost effective way to load balance clients in a multi-player online application while integrating a broad range of concerns such as social network cohesion.

### SUMMARY OF THE INVENTION

There are provided systems and methods for dynamic adaptive player cells for multi-player environments, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 presents a diagram of a system for providing dynamic adaptive player cells for multi-player environments, according to one embodiment of the present invention;

FIG. 2a presents a diagram of a dynamic adaptive player cell for multi-player environments, according to one embodiment of the present invention;

FIG. 2b presents a diagram of a virtual topography comprising dynamic adaptive player cells for multi-player environments, according to one embodiment of the present invention;

FIG. 2c presents a diagram for visualizing a proximity layer of dynamic adaptive player cells for multi-player environments, according to one embodiment of the present invention;

FIG. 3 presents a diagram of player cell transitions using dynamic adaptive player cells for multi-player environments, according to one embodiment of the present invention; and

FIG. 4 shows a flowchart describing the steps, according to one embodiment of the present invention, by which dynamic adaptive player cells for multi-player environments may be provided.

### DETAILED DESCRIPTION OF THE INVENTION

The present application is directed to a system and method for dynamic adaptive player cells for multi-player environments, such as massively multi-player environments. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings.

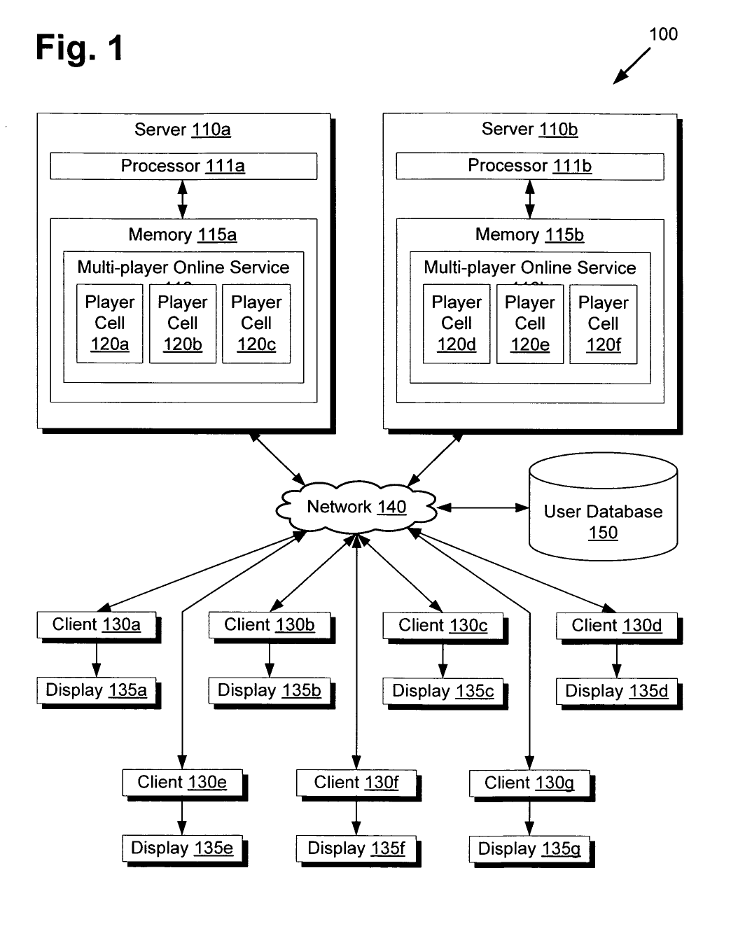

FIG. 1 presents a diagram of a system for providing dynamic adaptive player cells for multi-player environments, such as a massively multi-player environments, according to one embodiment of the present invention. Diagram 100 of FIG. 1 includes server 110a, server 110b, network 140, user database 150, clients 130a through 130g, and displays 135a through 135g. Server 110a includes processor 111a and memory 115a. Memory 115a includes multi-player online service 116a. Multi-player online service 116a includes player cell 120a, player cell 120b and player cell 120c. Server 110b includes processor 111b and memory 115b. Memory 115b includes multi-player online service 116b. Multi-player online service 116b includes player cell 120d, player cell 120e and player cell 120f.

Diagram 100 of FIG. 1 presents a simplified example of a system for supporting a multi-player online application such as an online game. As such, only two servers and seven clients are shown for simplicity, rather than hundreds of servers and thousands of clients as may be typical for a heavily loaded online application. Regardless of the particular numbers of clients and servers used, the final goal of efficiently distributing clients to servers remains the same.

However, simply distributing clients to servers based on performance metrics such as network latency and server load ignores other important concerns, such as social networks that may exist between players. As such, when distributing clients 130a through 130g, it is desirable to utilize other characteristics and parameters, such as user history and social networking data that may be available in user database 150, to provide a more optimal separation of users to servers.

To evenly distribute the processing load across multiple servers, players or clients may be distributed according to a broad grouping criterion, such as player location within the virtual online world or environment. In turn, each server may have the network bandwidth and processing resources to support many concurrent clients. However, for various reasons it may be desirable to limit the maximum number of clients visible to any client at a specific time. For example, client graphics rendering capability may be hardware limited, and users may be confused and overwhelmed if too many concurrent users are shown at the same time. To address these concerns, each server may support a number of client population limited units, or player cells, each hosting up to a specified maximum number of clients or players, such as 20 players. To prevent problems of sparseness, player cells may be programmed to reconfigure for a specified optimum population, which may be the same or less than the maximum population, and may be merged, thereby deleting old cells, or split, thereby creating new cells, as cell populations becomes too small or too large.

Thus, multi-player online service 116a and multi-player online service 116b may periodically re-evaluate the composition of each player cell and prepare transitions for players from one cell to another, if necessary. Advantageously, the player cells may be processed in a highly parallelized fashion amenable to modern multi-core processors. For load balancing and quality of service, each server may be configured to limit the maximum capacity of concurrent player cells according to available resources. For example, if a server exceeds its player cell capacity, it may transfer player cells to another server having remaining capacity, which may be negotiated using peer-to-peer or hierarchical command structures. In this manner, the users or clients 130a through 130g do not have to worry about selecting a specific server or instance to join, as the assigning of clients to specific player cells happens automatically and transparently to the user.

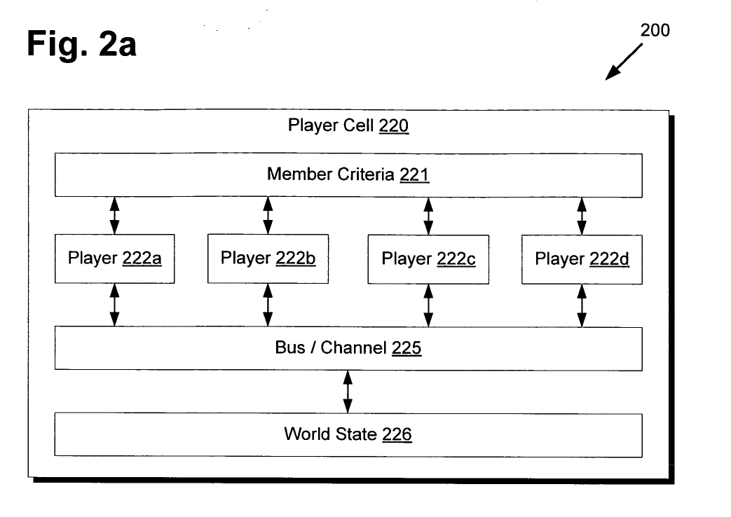

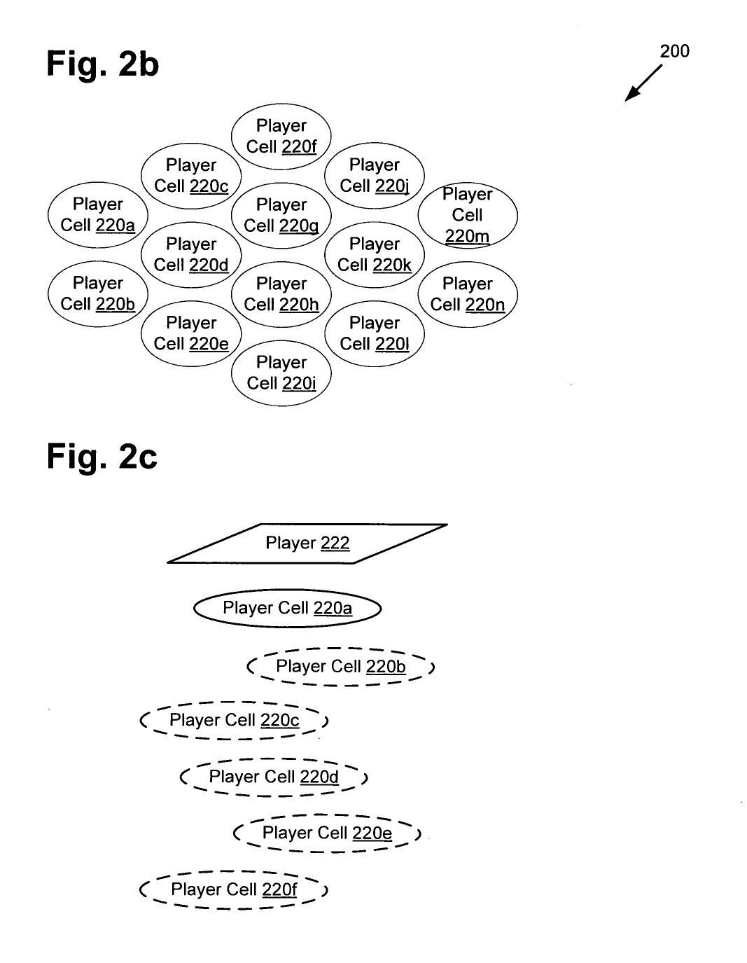

Moving to FIG. 2a, FIG. 2a presents a diagram of a dynamic adaptive player cell for multi-player environments, according to one embodiment of the present invention. Diagram 200 of FIG. 2a includes player cell 220. Player cell 220 includes member criteria 221, players 222a through 222d, bus/channel 225, and world state 226. With respect to FIG. 2a, player cell 220 may correspond to player cell 120a, 120b, 120c, 120d, 120e or 120f from FIG. 1.

Member criteria 221 may include any number of heuristic algorithms, parameters, and other base criteria for matching specific players or cell members to populate player cell 220. For example, member criteria 221 may include as a matching parameter a specific geographic region in the online world or game, such as a specific world area, map screen, building, dungeon, or other locale. This provides a practical method for limiting the processing load to a highly localized area within the online world for higher performance and quality of service. Another criteria might group users based on common quests, challenges, or game concepts, allowing users in similar situations to help each other. Yet another criteria might include grouping players based on movement patterns or location history, such as grouping users who are exploring unfamiliar new areas for their first time, or grouping users who tend to travel with each other. In this manner, users can be grouped with users having similar challenges and goals, which may facilitate easy group bonding and formation of new online relationships.

Member criteria 221 may also be affected and modified based on the player population composition within the cell. Thus, for example, based on a default setting or a specified user preference, players may be preferentially grouped based on game related avatar parameters such as character level, experience points, skill sets, classes or specializations, and equipment. This may, for example, facilitate the formation of player parties with similar skill levels and abilities. Another matching parameter may include grouping similar player behaviors or play patterns to encourage cooperative or competitive play. For example, players primarily interested in combat may be grouped with other combat oriented players, whereas players primarily interested in resource gathering may be grouped with other resource gatherers.

Data created from social interactions between users may also be utilized as matching parameters. For example, users may be matched based on social groupings such as friend lists, clans, teams, and guilds. History data such as chat logs or avatar proximity may also help group users already having established social relationships. If users would prefer to meet new random users, they may specify a preference to ignore social data. However, if users want to meet new but not completely random users, users might request a preference for grouping with friends of friends or other higher degrees of separation. Optionally, parental controls may lock some of the preferential grouping parameters, for example to restrict interactions only to previously known or trusted users.

User profile data, provided voluntarily or heuristically determined, may also be utilized as matching parameters. Thus, one example matching parameter may group users by physical geographic proximity, where user location may be determined by voluntarily submitted profile information or by other means such as geographic IP database lookup. Another matching parameter may group users with similar or dissimilar demographic or profile traits such as age, gender, occupation, hobbies, and other parameters. In this manner, depending on user preference, users can be matched with similar users to facilitate easier friendships through shared experience and interests, or users can be matched with dissimilar users to encourage new and interesting interactions.

Thus, after applying member criteria 221 to the population of available players, the player list within player cell 220 may include player 222a, 222b, 222c and 222d, as shown in FIG. 2a. As previously described, as players are added to player cell 220, the characteristics of the players themselves, or players 222a through 222d, may affect the matching criteria used in member criteria 221. To reduce processing time, the population of available players may be pruned using the most highly restrictive parameters first, such as player location within the online virtual world or environment. Additionally, although players 222a through 222d are all shown to be selected as a result of member criteria 221, alternative embodiments may only select a portion of the population based on member criteria 221. This may, for example, allow approximately half of a cell population to be grouped based on similar grouping characteristics, and the other half of the cell population to be randomly selected to provide more chances for users to meet new and different users.

As shown in FIG. 2a, players 222a through 222d can all see and communicate with each other through a shared bus/channel 225, thereby providing a fully connected member graph of communication between all players within player cell 220. However, the ability to chat with other players outside of the hosted player cell may be provided, for example, to allow chat with all users on a friends list regardless of player cell membership.

Additionally, a unique world state 226 is maintained for all players within player cell 220, which may be updated using a separate process or thread for each player cell. Thus, while the state and the visual perception of the virtual world or environment may differ somewhat between player cells, the processing of the virtual world is advantageously divided into manageable chunks of very limited scope, facilitating back-end server operation. If necessary, the changes to world state 226 and the individual world states of other player cells may be re-integrated into a larger global world state or database when possible, for example at periodic intervals or during low server load. In this manner, the overall world state may be kept consistent.

Moving to FIG. 2b, FIG. 2b presents a diagram of a virtual topography comprising dynamic adaptive player cells for multi-player environments, according to one embodiment of the present invention. Diagram 200 of FIG. 2b includes player cells 220a through 220n. With respect to FIG. 2b, each of player cells 220a through 220n may correspond to player cell 220 from FIG. 2a.

As shown in diagram 200 of FIG. 2b, player cells 220a through 220n are distributed evenly, which may be appropriate clients are also evenly distributed in the virtual environment. In this case, the closest player cell may host the player as the player travels across the landscape shown in diagram 200 of FIG. 2b. However, in many situations, virtual environments will have highly populated areas, such as towns and other points of interest, and sparsely populated areas, such as fields and wilderness. In these situations, rather than evenly distributing player cells, player cells may be concentrated and overlapping in highly populated areas, whereas a smaller number of player cells with larger proximity sizes may be used for sparsely populated areas. When a player encounters an area with a high concentration of overlapping player cells, the most appropriate player cell may host the player, according to various matching criteria as previously described.

Thus, moving to FIG. 2c, FIG. 2c presents a diagram for visualizing a proximity layer of dynamic adaptive player cells for multi-player environments, according to one embodiment of the present invention. Diagram 200 of FIG. 2c includes player 222 and player cells 220a through 220f. With respect to FIG. 2c, player 222 may correspond to one of player 222a through 222d from FIG. 2a, and player cells 220a through 220f may each correspond to player cell 220 from FIG. 2a.

Diagram 200 of FIG. 2c depicts a situation where a player, or player 222, may be matched to several overlapping candidate cells, or player cells 220a through 220f. By evaluating the matching criteria in player cells 220a through 220f, player cell 220a may be determined to be the most appropriate match for player 222. For example, player cell 220a may already include several friends of player 222. If player cell 220a is already full, then the least relevant player in player cell 220a might be moved to another player cell. Alternatively, player cell 220a may split into two player cells. Thus, as player 222 explores the online virtual world or environment, player 222 may be assigned and reassigned to the most relevant player cells according to various matching criteria set by user preferences or by server defaults, and the player cells may reconfigure by adjusting, splitting, or joining accordingly.

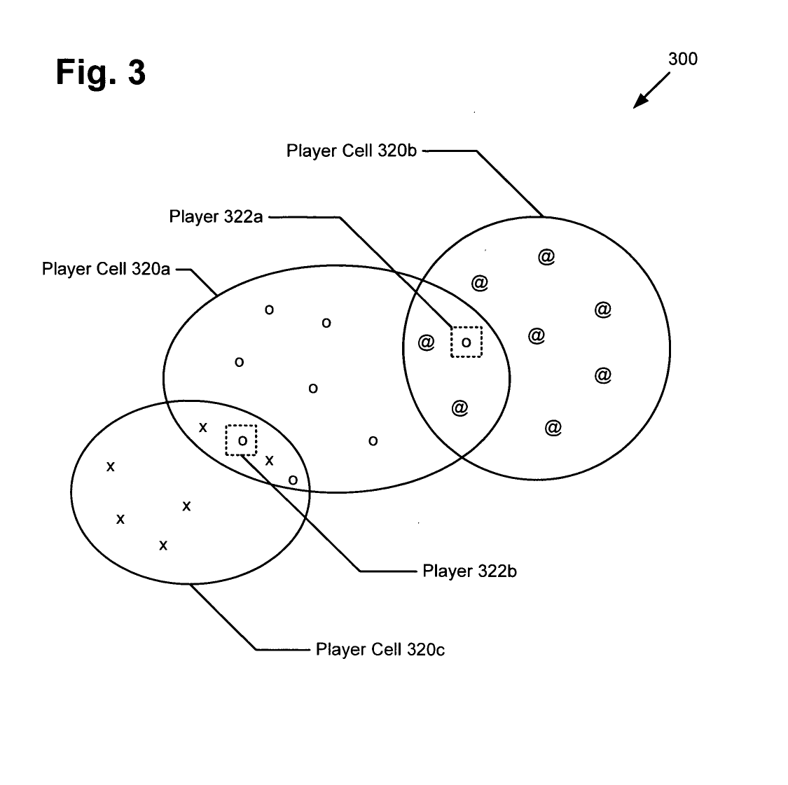

Moving to FIG. 3, FIG. 3 presents a diagram of player cell transitions using dynamic adaptive player cells for multi-player environments, according to one embodiment of the present invention. Diagram 300 of FIG. 3 includes player cells 320a, 320b, and 320c. Player cell 320a includes player 322a and player 322b. With respect to FIG. 3, player cells 320a through 320c may each correspond to player cell 220 from FIG. 2a.

As shown in diagram 300 of FIG. 3, the cell members or players of player cell 320a are indicated by the “o” symbol, whereas the cell members or players of player cell 320b are indicated by the “@” symbol, and the cell members or players of player cell 320c are indicated by the “x” symbol. Moreover, since player cell 320a overlaps partially with player cell 320b and 320c, some players may transition to other player cells, if appropriate, when the players occupy the overlapping area.

For example, player 322a may represent a player that has wandered away from the rest of the cell members in player cell 320a. Thus, proximity wise, player 322a may now be a better match for player cell 320b, and player 322a may be transitioned from an “o” member in player cell 320a to a “@” member in player cell 320b. While proximity may comprise only one of the member criteria within each player cell, it may be weighted as a high priority criterion. Thus, even if the members of player cell 320a may match other parameters of player 322a more closely, such as avatar statistics and social bonds, the spatial proximity and movement pattern of player 322a towards player cell 320b may outweigh the secondary parameters that more closely match to player cell 320a.

In another example, player 322b may represent a player that is training and has increased experience level from level 3 to level 4. One matching criteria of player cell 320a may be a preference for level 3 characters, whereas one matching criteria of player cell 320c may be a preference for level 4 characters, thereby helping to group users with similar skills and capabilities. Assuming that all other matching criteria are neutral or do not apply, then player 322b may transition as a “o” member from player cell 320a to a “x” member in player cell 320c.

Thus, player composition within the player cells may be re-evaluated and adjusted as necessary, continually matching the most relevant fellow players without any manual intervention required from the players. However, as players are moved from one player cell to another, the composition of visible players changes as well. To make these transitions appear smooth and natural from the perspective of the transitioning player, other players from the old player cell may disappear from the screen by walking, running, operating a vehicle, teleporting, or using some other means of transportation. In reverse fashion, other players from the new player cell may appear on the screen using similar methods, for example by appearing from the edges of the screen. These transitions may be staggered somewhat randomly to provide a natural appearance of old avatars leaving and new avatars appearing, as if by their own volition rather than forced by the system. From the perspective of the other users in the old player cell, the transitioning player may also disappear from the screen in a similar fashion, and from the perspective of the other users in the new player cell, the transitioning player may appear on the screen.

Additionally, the virtual environment or world may appear to gradually transition to reflect any differences in world state from the old player cell to the new player cell. For example, if a harvestable fruit tree is full of fruit in the world state of the old player cell but picked barren in the world state of the new player cell, the transitioning player might observe other players picking at the fruit tree until it becomes barren. If a door that was closed in the old player cell is now open in the new player cell, another player might be seen opening the door for the transitioning player. Thus, player population transitions and world state changes from one player cell to another player cell can be visually translated to the displays of each client in a smooth and convincing manner, avoiding sudden and jarring visual transitions that may break player immersion.

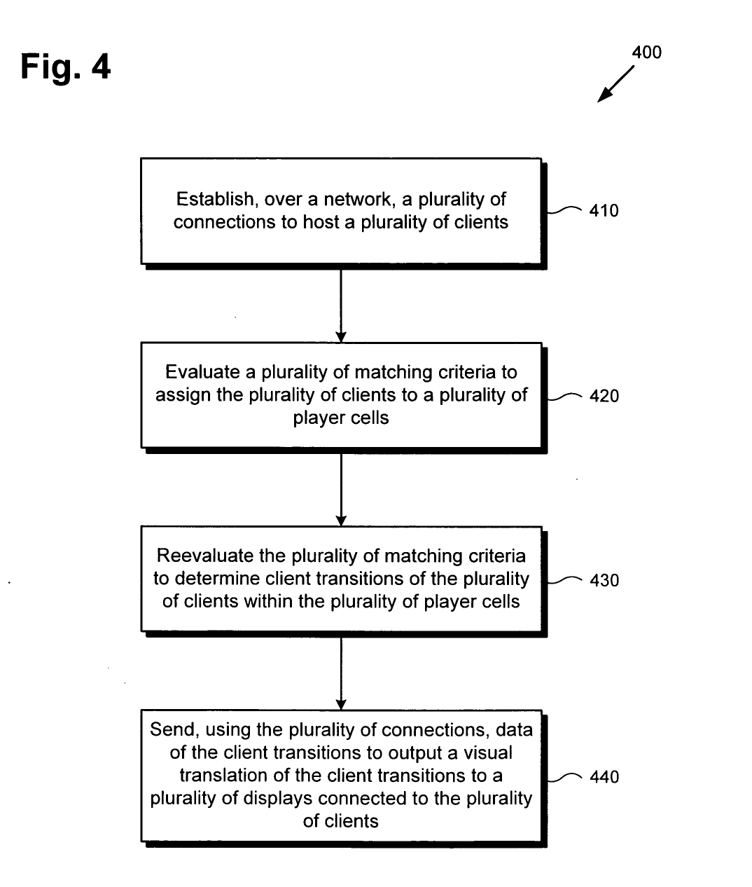

FIG. 4 shows a flowchart describing the steps, according to one embodiment of the present invention, by which dynamic adaptive player cells for multi-player environments may be provided. Certain details and features have been left out of flowchart 400 that are apparent to a person of ordinary skill in the art. For example, a step may comprise one or more substeps or may involve specialized equipment or materials, as known in the art. While steps 410 through 440 indicated in flowchart 400 are sufficient to describe one embodiment of the present invention, other embodiments of the invention may utilize steps different from those shown in flowchart 400.

Referring to step 410 of flowchart 400 in FIG. 4 and diagram 100 of FIG. 1, step 410 of flowchart 400 comprises processor 111a of server 110a establishing, over network 140, a plurality of connections to host a plurality of clients. As previously discussed, clients may be load balanced to servers based on peer-to-peer or hierarchical command structures. For example, in a hierarchical embodiment an intermediary redirection server may match a client to a server based on a broad grouping criteria such as player location in the game world, where each server is responsible for a particular region of the game world. In a peer-to-peer embodiment, servers may by accept and redistribute client loads to other servers without a centralized control server. In either case, for simplicity it may be assumed that clients 130a through 130g are all assigned to the same server 110a. Thus, in step 410, multi-player online service 116a executing within memory 115a on processor 111a may establish connections over network 140 to clients 130a through 130g.

Referring to step 420 of flowchart 400 in FIG. 4 and diagram 100 of FIG. 1, step 420 of flowchart 400 comprises processor 111a of server 110a evaluating a plurality of matching criteria to assign the plurality of clients connected from step 410 to a plurality of player cells, or player cells 120a, 120b and 120c. Thus, as shown in diagram 200 of FIG. 2a, each player cell may have member criteria to be evaluated to determine the cell members or players within a particular cell. Additionally, as players are added to a player cell, the characteristics of the players themselves may in turn influence the member criteria of the player cell. As previously described, the member criteria may include a wide range of user preferences and heuristic algorithms to group users based on proximity, player types and behaviors, social relationships, user profiles, and other data. Thus, clients 130a through 130g may be hosted in player cells 120a, 120b and 120c as appropriate, depending on the member criteria of each player cell, which may for example utilize data retrieved from user database 150. As previously described, multi-player online service 116a may generate new player cells to accommodate new clients, may split or join player cells to maintain optimum player cell populations, and may transfer player cells to other servers such as server 110b for load balancing.

Referring to step 430 of flowchart 400 in FIG. 4 and diagram 100 of FIG. 1, step 430 of flowchart 400 comprises processor 111a of server 110a reevaluating the plurality of matching criteria to determine client transitions of the plurality of clients, or clients 130a through 130g, within the plurality of player cells, or player cells 120a through 120c. For example, moving to FIG. 3, where player cell 320a corresponds to player cell 120a, player cell 320b corresponds to player cell 120b, and player cell 320c corresponds to player cell 120c, step 430 may determine two transitions, one for player 322a transitioning from player cell 320a to player cell 320b, and another for player 322b transitioning from player cell 320a to player cell 320c. As previously described, the first transition for player 322a may be due to reevaluating the proximity of player 322a away from the members of player cell 320a and towards the members of player cell 320b. The second transition for player 322b may be due to reevaluating the player status of player 322b after advancing from level 3 to level 4, wherein player cell 320a has a preference for level 3 characters whereas player cell 320c has a preference for level 4 characters.

Referring to step 440 of flowchart 400 in FIG. 4 and diagram 100 of FIG. 1, step 440 of flowchart 400 comprises processor 111a of server 110a sending, using the plurality of connections established in step 410, data of the client transitions determined from step 430 to output a visual translation of the client transitions to a plurality of displays connected to the plurality of clients, or displays 135a through 135g. As previously described, the visual translation provides a smooth visual transition between the old player cell and the new player cell, including changes to cell population and world state.

For example, if the player associated with client 130a is transitioned from player cell 120a to player cell 120b, then client 130a as well as any other clients in player cell 120a and player cell 120b will output a virtual translation of the transition on their respective displays. Assuming that clients 130b through 130d are hosted in player cell 120a, clients 130e through 130g are hosted in player cell 120b, and client 130a is transitioning from player cell 120a to player cell 120b, display 135a may depict the avatars of clients 130b through 130d leaving and the avatars of clients 130e through 130g joining, displays 135b through 135d may depict the avatar of client 130a leaving, and displays 135e through 135g may depict the avatar of client 130 joining. Additionally, as previously stated, display 135a may depict the avatars of clients 130b through 130d leaving and the avatars of clients 130e through 130g joining in a gradual and staggered fashion to more closely mimic natural user behavior. Thus, the user of client 130a does not observe on display 135a a large group of users suddenly leaving and joining, but rather users naturally coming and going as if controlled manually by other users.

Additionally, if any changes to the world state between player cell 120a and 120b result in visual differences, these visual differences may also be shown in the visual translation shown on display 135a, and any of the avatars of clients 130b through 130g might be utilized as actors in enacting world state changes. Alternatively, non-player characters (NPCs) or other events may be utilized to provide a visual rationale for world state changes, thereby avoiding any jarring and sudden visual shifts from transitioning to a new player cell having a new world state.

Steps 430 and 440 may then be continually repeated, for example on a periodic basis, to maintain the most optimal set of player cells, satisfying various user preferences and cell membership criteria. In this manner, users can experience the large and open feeling of multi-player online worlds while interacting with the most relevant and desirable population of fellow players. Since the grouping or matching criteria may be influenced by user preferences, advanced users can customize their experience as they see fit, for example by preferring groupings with fellow guild members, whereas novice users may simply rely on default matching parameters and defer customization until later. By transparently matching users to player cells with relevant and interesting people, even new users can quickly establish new online friendships without the traditional interface burdens of navigating such online environments, such as negotiating a common server or instance to meet, avoiding overloaded or sparsely populated servers, and struggling with other technical details that may detract from the online experience and discourage users from playing. Additionally, since the player cells can be readily processed by highly scalable and low cost distributed server infrastructure, providers may avoid the cost of high performance monolithic server equipment while providing superior quality of service.

From the above description of the invention it is manifest that various techniques can be used for implementing the concepts of the present invention without departing from its scope. Moreover, while the invention has been described with specific reference to certain embodiments, a person of ordinary skills in the art would recognize that changes can be made in form and detail without departing from the spirit and the scope of the invention. As such, the described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A server supporting dynamic adaptive player cells for multi-player environments, the server comprising a processor configured to:
establish, over a network, a plurality of connections to host a plurality of clients;
evaluate a plurality of matching criteria to assign the plurality of clients to a plurality of player cells;
reevaluate the plurality of matching criteria to determine client transitions of the plurality of clients within the plurality of player cells; and
send, using the plurality of connections, data of the client transitions to output a visual translation of the client transitions to a plurality of displays connected to the plurality of clients.

2. The server of claim 1, wherein each of the plurality of player cells is limited by a maximum client population.

3. The server of claim 1 wherein the processor is further configured to:
reconfigure the plurality of player cells by merging or splitting to maintain optimal matching of the plurality of matching criteria to the plurality of player cells.

4. The server of claim 1 wherein the processor is further configured to:
transfer a subset of the plurality of player cells to another server for load balancing.

5. The server of claim 1, wherein the plurality of matching criteria includes a preference for grouping clients by spatial proximity of associated avatars within a virtual environment.

6. The server of claim 1, wherein the plurality of matching criteria includes a preference for grouping clients having established social relationships.

7. The server of claim 1, wherein the plurality of matching criteria includes a preference for grouping clients by associated avatar parameters.

8. The server of claim 1, wherein the plurality of matching criteria includes a preference for grouping clients by user profile data.

9. The server of claim 1, wherein the visual translation includes the movement of avatars corresponding to the plurality of clients to reflect the client transitions.

10. The server of claim 1, wherein the visual translation includes transitions to reflect world state changes between player cells in the client transitions.

11. A method for providing dynamic adaptive player cells for multi-player environments, the method comprising:
establishing, over a network, a plurality of connections to host a plurality of clients;
evaluating a plurality of matching criteria to assign the plurality of clients to a plurality of player cells;
reevaluating the plurality of matching criteria to determine client transitions of the plurality of clients within the plurality of player cells; and
sending, using the plurality of connections, data of the client transitions to output a visual translation of the client transitions to a plurality of displays connected to the plurality of clients.

12. The method of claim 11, wherein each of the plurality of player cells is limited by a maximum client population.

13. The method of claim 11 further comprising:
reconfiguring the plurality of player cells by merging or splitting to maintain optimal matching of the plurality of matching criteria to the plurality of player cells.

14. The method of claim 11 further comprising:
transferring a subset of the plurality of player cells to another server for load balancing.

15. The method of claim 11, wherein the plurality of matching criteria includes a preference for grouping clients by spatial proximity of associated avatars within a virtual environment.

16. The method of claim 11, wherein the plurality of matching criteria includes a preference for grouping clients having established social relationships.

17. The method of claim 11, wherein the plurality of matching criteria includes a preference for grouping clients by associated avatar parameters.

18. The method of claim 11, wherein the plurality of matching criteria includes a preference for grouping clients by user profile data.

19. The method of claim 11, wherein the visual translation includes the movement of avatars corresponding to the plurality of clients to reflect the client transitions.

20. The method of claim 11, wherein the visual translation includes transitions to reflect world state changes between player cells in the client transitions.
